(19) United States
(12) Patent Application Publication
(10) Pub. No.: US 2007/0187428 A1
(43) Pub. Date: Aug. 16, 2007

(54) SHUTOFF DEVICE FOR PACKAGES OF LIQUID PRODUCTS

(76) Inventors: Viktorija Dzabrailova, Rigas (LV); Igor Dubovskij, Novokuznetsk (RU)

Correspondence Address: ABELMAN, FRAYNE & SCHWAB, 666 THIRD AVENUE, 10TH FLOOR, NEW YORK, NY, 10017, US

(21) Appl. No.: 11/674,937

(22) Filed: Feb. 14, 2007

(30) Foreign Application Priority Data
Feb. 15, 2006 (LV) LV P-06-26

(51) Int. Cl. B67D 5/00

(52) U.S. Cl. 222/83

(57) ABSTRACT

A shutoff device designed for the capping of semi-rigid packages composed of non-vitreous, non-metallic flexible sheet material, such as those cartons containing sterilized food products, for example, fruit juices and milk. The reusable shutoff device includes a base connected integrally with the package by the supporting surface, and the tooth cutting member, the sleeve connected with the base by the threaded joint, and the cap connected with the sleeve by the splined joint. Between the supporting surface and the cylindrical part of the base the flexible bridge is made, and the sleeve has the pusher, which is acting on the weakened element arranged at the bottom of the cap. The shutoff device improves the visual demonstrativeness of the indication of the initial unsealing of the package and makes the package easy to use.

### BACKGROUND OF THE INVENTION

1. Field of the Invention

This invention relates to threaded shutoff devices provided with means of indicating an uncapped configuration which is installed on packages of liquid products having partitions which are broken upon uncapping of a package. The proposed threaded shutoff device is designed preferably for semi-rigid cartons made of, for example, non-vitreous, non-metallic flexible sheet material, such as those cartons commercially available as “TETRA PAK” packaging from “TETRA LAVAL HOLDINGS & FINANCE S.A. CORPORATION” for packages of juices, milk, etc.

2. Description of the Related Art

It is known that reusable shutoff devices are available for packages such as cartons made of, for example, non-vitreous, non-metallic flexible sheet material, such as those cartons commercially available as “TETRA PAK” packaging from “TETRA LAVAL HOLDINGS & FINANCE S.A. CORPORATION” for packages of juices, milk, etc. Such a shutoff device is described in European Patent Application EP 1 533 240, Int. C1.7: B65D 5/74, taken as a prototype. The shutoff device is fixed on a package casing above its breakable partition, and has a base, in the cylindrical part, that is a pour opening, in which internal threads and external threads are made, such as, for example, internal right-handed threads and external left-handed threads.

The second element of the shutoff device is a cap that closes the pour opening at the end of the cylindrical part of the base. In the assembled condition of the shutoff device the cap is screwed on the cylindrical part of the base. The cap in its inner part has pins arranged in the axial direction. Inside the cylindrical part of the base on the threaded joint having a left-handed thread, there is a sleeve movable in an axial and angular direction, on the lower end of which there are sharpened teeth. On the inner surface of the sleeve there are longitudinal ridges engaged with pins of the cap. Between the protruding shoulder on the base of the shutoff device and the cap there is a tear-off ring connected with the cap with breakable bridges.

Upon screwing the cap off the cylindrical part of the base during package uncapping, the ring is detached from the cap, while the radial movement of the ring is limited by the shoulder of the base. The detachment of the ring is indicative of package uncapping. Concurrently, along with the screwing off of the cap, the sleeve rotated by pins of the cap along the left-handed thread of the cylindrical part of the base moves towards the breakable partition in the package wall, and rotation about the axis cuts the partition circumferentially off the package wall by its sharpened teeth.

The disadvantage of the known shutoff device is a poor demonstrativeness of the fact of indication of the first uncapping of the package, in which the tear-off ring after the break of the bridges is retained on the cylindrical part of the base, that does not provide proper visual indication of the breaking of integrity of a package. Furthermore, when screwing off the cap, the cap is not structurally connected with the base of the shutoff device and may be lost during the pouring of the product in the package. Occasional spillage of liquid product is possible during uncapping of the package upon slight squeezing of side wall of semi-rigid package.

### BRIEF SUMMARY OF THE INVENTION

The object of the present invention is to improve the demonstrativeness of the indication of uncapping of the package and to make possible the multiple occurrences of capping and uncapping of the package with no separation of the closing element; that is, the cap, and to prevent the possibility of occasional spillage of liquid product upon uncapping of the package,

This object is achieved in a shutoff device by providing a weakened element and including a base, which is by its supporting surface attached above the partition of the package broken by tooth cutting member, with the sleeve connected with the base by the threaded joint, and the cap connected with the sleeve by a splined joint, and between the cylindrical part of the base and supporting surface a flexible bridge is made. The tooth cutting member is arranged on the lower edge of the cylindrical part of the base, and the sleeve has a cylindrical pusher, which interacts by its end face with the weakened element, which is arranged at the bottom of the cap, while the inner edge of the cylindrical pusher together with conical element of the base form a valve couple seat-closing element.

### BRIEF DESCRIPTION OF THE SEVERAL VIEWS OF THE DRAWINGS

The essence of the invention is explained with reference to the drawing, wherein:

FIG. 1 illustrates a cross-sectional view of the shutoff device for packages.

### DETAILED DESCRIPTION OF THE INVENTION

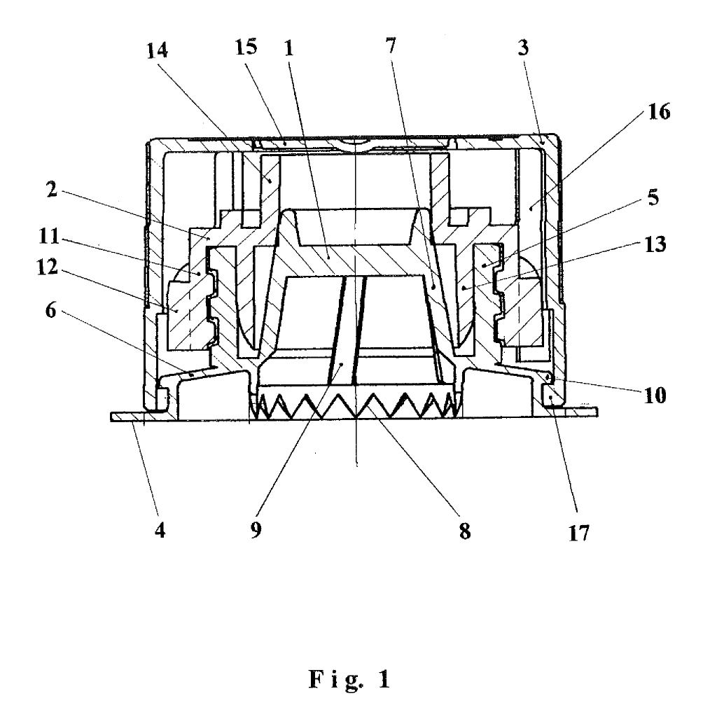

As illustrated in FIG. 1, the shutoff device comprises the base 1, the sleeve 2 and the cap 3. The base 1 is attached to a surface of the package (not shown in the drawing) by the supporting surface 4 over its breakable partition. The base 1 has a cylindrical part 5 with the thread on the outer surface connected with the supporting surface 4 by flexible bridge 6. The base 1 has also a conical part 7 and a tooth cutting member 8, connected with each other by inclined struts 9. At the lower part of the base 1 there is a circular shoulder 10.

The sleeve 2 has three cylindrical elements: the outer element 11 with the thread on its inner surface and radial splines between longitudinal ribs 12 on the outer surface, the tubular sealing element 13, and cylindrical pusher 14.

At the bottom of the cap 3 there is the weakened element 15, while on the inner surface there are radial ribs 16 and catches 17 in the lower part of the inner surface.

In the assembled condition of the shutoff device, the sleeve 2 along the thread on the outer surface of the cylindrical part 5 is screwed on against the stop on the base 1. The tubular sealing element 13 of the sleeve 2 together with the inner surface of the cylindrical part 5 forms a hermetic seal. The cap 3 upon the axial fitting on the base 1 by its radial ribs 16 goes into a splined joint with the radial splines between the ribs 12 on the outer surface of the sleeve 2, and the catches 17 latch beyond the circular shoulder 10 in the lower part of the base 1, forming a permanent joint thereof. The shutoff device is bonded by the supporting surface 4 to the surface of the package over its breakable partition.

Upon unsealing of the package the cap 3 is rotated, for example, counterclockwise, with the direction of rotation of the cap 3 being shown by an arrow on the outer side of the bottom. The catches 17 prevent the axial displacement of the cap 3 relative to the base 1. The radial ribs 16 of the cap 3 being in the splined joint with the radial ribs 12 on the outer surface of the sleeve 2, rotate it, at the result of which the sleeve 2 is displaced along the thread in axial direction relative to the base 1.

At first the stop of the cylindrical pusher 14 against the bottom of the cap 3 provides the flexure of the flexible bridge 6 and the penetration of teeth of the cutting member 8 to the size of flexure of the bridge 6 into the breakable partition of the package and, thus providing breaking of integrity. Then, upon further rotation of the cap 3 the pressure of the cylindrical pusher 14 upon the bottom of the cap 3 is increased, bridges of the weakened element 15 are broken, and the element is removed. The detachment of the significant part of the cap is a visual evidence of the fact of unsealing of the package. With that the cylindrical pusher 14 comes out of the outer surface of the cap 3 extending the pour opening, while due to the axial displacement of the sleeve relative to the base 1 the valve seat-closing element is opened between the conical element 7 of the base 1 and the inner edge of the inner surface of the cylindrical pusher 14. After the weakened element 15 is broken the base 1 reassumes its original position under the action of a force of the flexible bridge 6, and the holes in the safety partition of the package are released from the teeth of the cutting member 8 with the formation of holes in the safety partition used for liquid flowing. After the consumption of a beverage the valve seat-closing element safely closes a discharge channel of the shutoff device by, for example, counter-rotation of the cap.

As it follows from the description of the invention the proposed shutoff device for packages of liquid product provides proper visual indication of the breaking of integrity of a package, the possibility of the multiple cappings and uncappings of the discharge channel of the shutoff device, and the formation of the discharge channel, which has an adequate resistance to liquid flowing, with resistance of the holes in the breakable partition of the package, resistance of the passage in the valve and the discharge channel elongated by the extended cylindrical pusher 14, that prevents undesirable spillage of liquid upon the unsealing of filled semi-rigid package that may occur when the known shutoff devices are installed.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A shutoff device for a package of liquid product provided with a weakened element, the shutoff device comprising:
a base, which is, by a supporting surface, attached above a partition of the package broken by a tooth cutting member,
a sleeve connected with a cylindrical part of the base by a threaded joint, and
a cap connected with the sleeve by a splined joint, wherein between the cylindrical part of the base and the supporting surface, a flexible bridge is provided, a tooth cutting member is arranged on a lower front edge of the cylindrical part of the base, and the sleeve has a cylindrical pusher which interacts by an end face with the weakened element, which is arranged at the bottom of the cap.

2. A shutoff device according to claim 1, wherein the base is provided with a conical element, which forms, with the inner edge of the cylindrical pusher of the base, a valve couple seat-closing element.

3. A shutoff device according to claim 1, wherein the sleeve is provided with a tubular sealing element, which together with the inner surface of the cylindrical part of the base forms a hermetic seal.

4. A shutoff device according to claim 2, wherein the sleeve is provided with a tubular sealing element, which together with the inner surface of the cylindrical part of the base forms a hermetic seal.
